(19) United States
(12) Patent Application Publication
(10) Pub. No.: US 2014/0196824 A1
(43) Pub. Date: Jul. 17, 2014

(54) Tire traction device

(71) Applicant: Neal Conner, Kenmore, WA (US)

(72) Inventor: Neal Conner, Kenmore, WA (US)

(21) Appl. No.: 13/694,902

(22) Filed: Jan. 17, 2013

(51) Int. Cl. B60C 27/00

(52) U.S. Cl. CPC B60C 27/003
USPC 152/221

(57) ABSTRACT

A device to enhance tire traction comprises a two sided strip, one side of which is adhesive to the surface of a tire and the other side of which has affixed pebbles or similar discrete hard objects such as gravel, providing a traction surface for the tire. The discrete objects are roughly 5 to 12 millimeters along major axes and are as thin as 2 to 3 millimeters. The discrete objects are affixed to the strip with a spacing between adjacent objects averaging 5 to 10 millimeters, thereby providing interstices between the objects.

### BACKGROUND OF THE INVENTION

1. Field of the Invention

This invention relates to a device that attaches to tires to enhance tire traction in slippery conditions. More specifically, this invention relates to a two sided strip, one side of which is adhesive to the surface of the tire and the other side of which has attached pebbles or similar discrete objects providing a traction surface for the tire.

2. Description of the Related Art

In slippery, wet snow, standard vehicle tires slip and have difficulty gaining or maintaining traction. It is desirable to attach some contrivance to the surface of the tire to enhance tire traction under such conditions.

Related art, such as U.S. patent application publication number 2008/0190531 by Holyfield, discloses an adhesive patch comprising a flat, rectangular panel, on one surface of which is an adhesive allowing the patch to be temporarily affixed to the surface of a tire, and the other surface of which includes an abrasive gripping surface, as illustrated in FIG. 1a. As taught, such a patch comprises a foam strip 102, one surface of which 104 comprises an adhesive for attachment to the tire 108, the other surface of which 106 comprises an abrasive surface for traction on the road. The deficiency of such a contrivance to provide sustained traction, however, is illustrated in FIGS. 1b and 1c. Turning to FIG. 1b, as the tire 108 moves over icy roadbed 110, ice and snow from roadbed 110 is compressed by tire 108 against outer surface 106 to form an icy coating 112 on the outside of outer surface 106. As illustrated in FIG. 1c, this icy outer coating 112 adhering to abrasive surface 106 persists as the tire rotates and is then presented by the tire to the icy roadbed, whereby slippage occurs.

What is needed is a patch that adhesively attaches to a tire, presenting a traction surface for the tire to the roadbed, wherein snow and ice from the roadbed do not persistently form an icy coating on the traction surface and thereby the patch continually presents an effective traction surface for the tire to the roadbed.

### BRIEF SUMMARY OF THE INVENTION

The present invention provides a two sided strip, one side of which is adhesive to the surface of the tire and the other side of which has affixed pebbles or similar discrete hard objects providing a traction surface for the tire. The discrete objects may be rounded flattened ovoid or ellipsoid in shape or they may be irregular gravel or similar material, roughly 5 to 12 millimeters along major axes and as thin as 2 to 3 millimeters in thickness in some embodiments. Advantageously, the discrete objects are affixed to the strip so as to leave substantial spaces between the objects to provide interstices affording the utility of the invention described herein, the spaces being up to 5 to 10 millimeters in some embodiments.

### BRIEF DESCRIPTION OF THE DRAWINGS

The foregoing objects, as well as further objects, advantages, features and characteristics of the present invention, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1a is a cross-sectional exploded view of a portion of the prior art invention adhering to a tire;

FIGS. 1b and 1c depict the operation of the prior art invention, showing the shortcomings thereof;

FIG. 2 is a cross-sectional exploded view of a portion of the present invention adhering to a tire;

FIG. 3 is an overhead view of the present invention showing the side of the strip to which the discrete objects are affixed; and

FIGS. 4 and 5 depict the operation of the present invention.

### DETAILED DESCRIPTION OF THE INVENTION

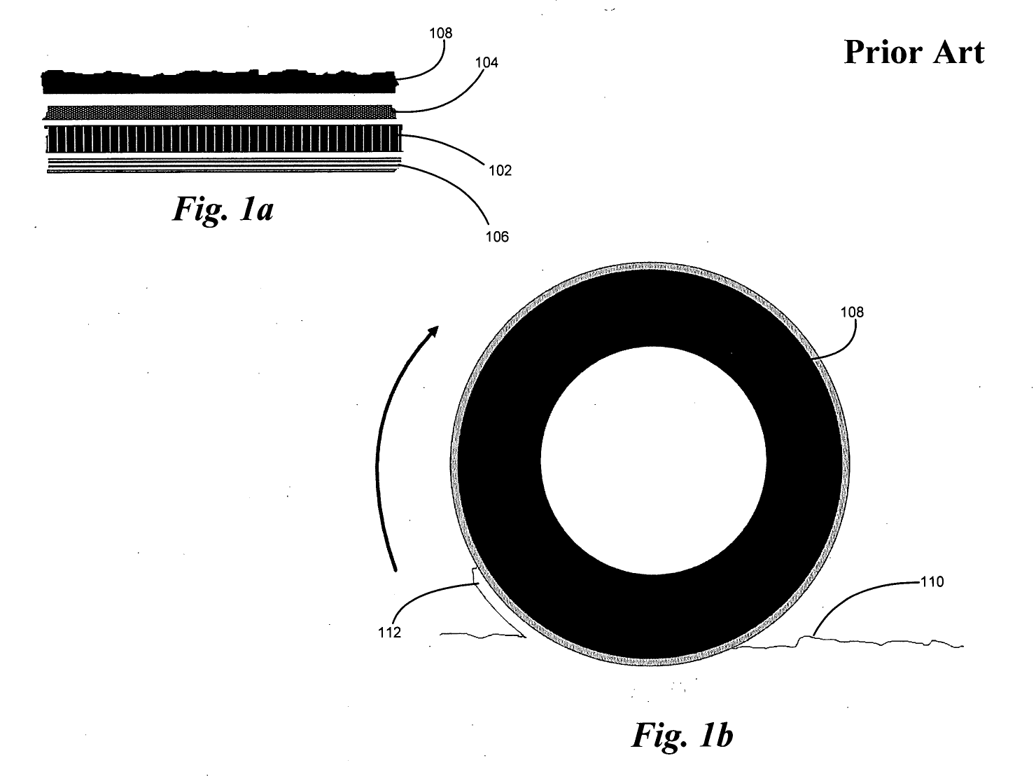

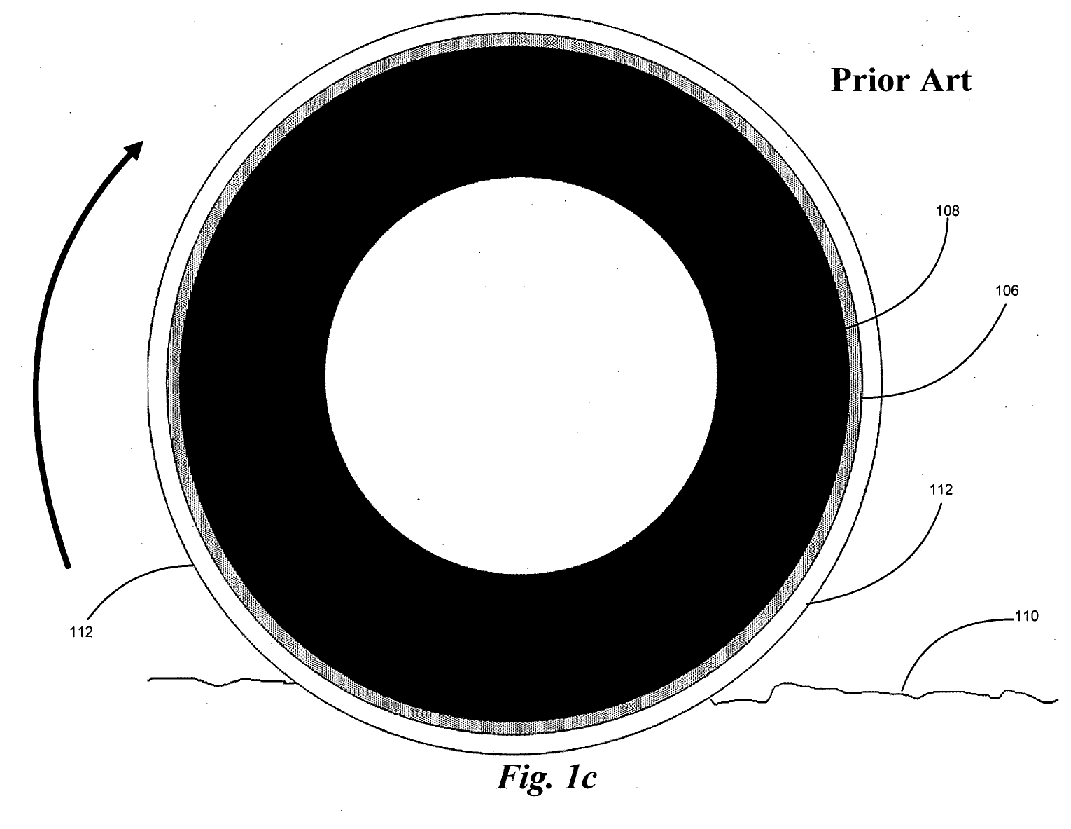

The shortcomings of the related art are discussed above in reference to FIGS. 1a, 1b and 1c.

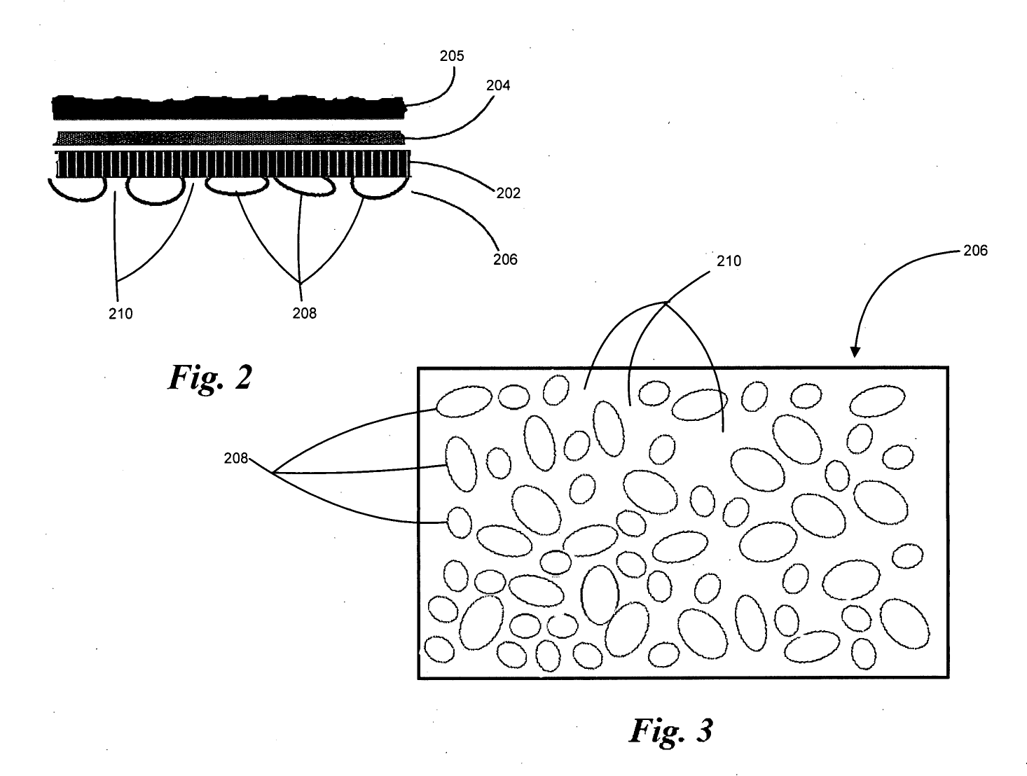

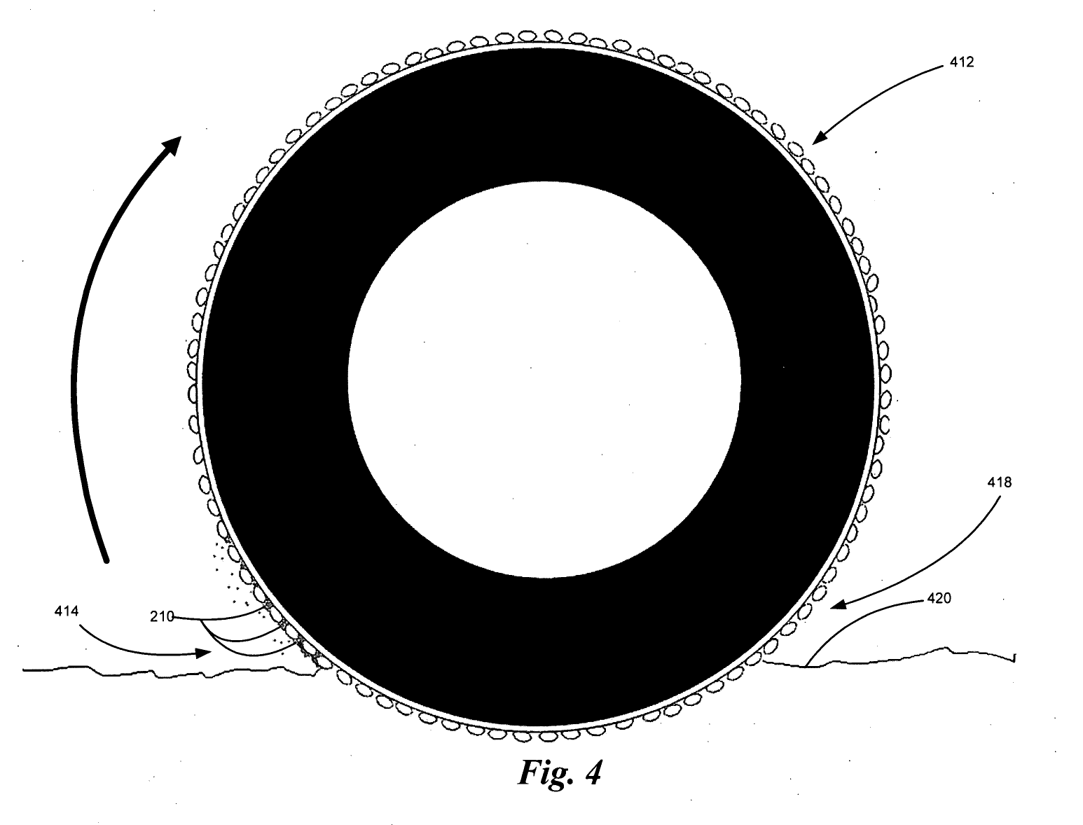

Referring now to FIGS. 2 and 3, a strip 202 is provided, on one side of which is adhesive 204 for adhesion to the surface of a tire 205 and on the other side 206 of which are a plurality of pebbles 208 affixed to the strip with a glue. Advantageously, lying between pebbles 208 are spaces providing interstices 210.

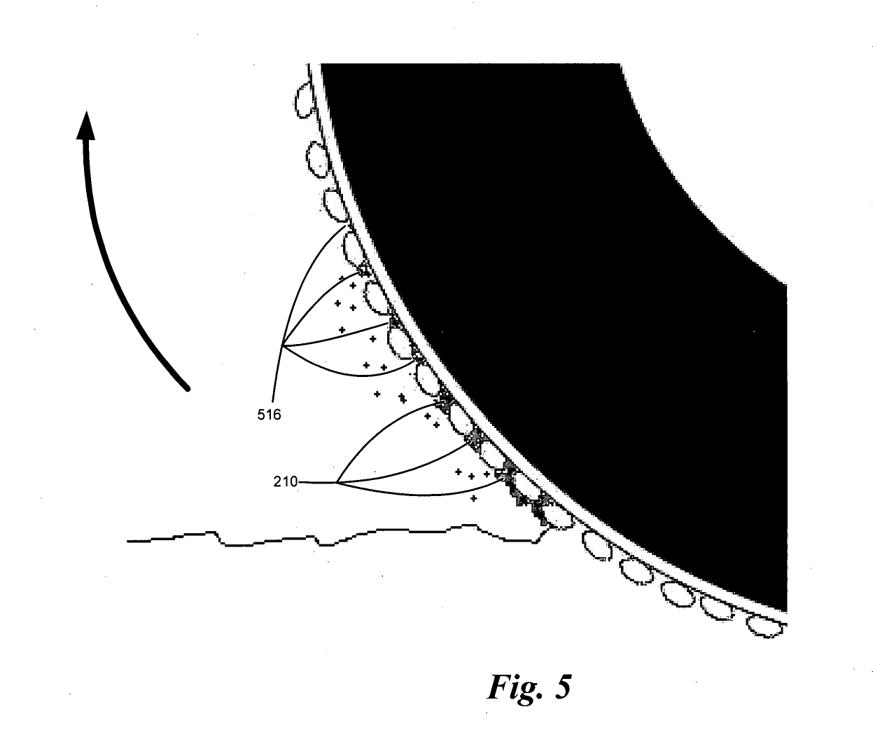

Referring to FIGS. 4 and 5, as tire 412 advances, icy snow from roadbed 420 is compacted into interstices 210. However, at the trailing side 414 of tire 412, as tire 412 rotates and the strip moves up along the circumference of tire 412, the natural flexion of tire 412 in motion results in deformation within interstices 210, causing fractionation of icy snow in interstices 210, and, as illustrated in interstices 416 in FIG. 5, at least some of the icy snow falls out of the interstices 210 moving forward on trailing side 414. Accordingly, upon coming around to leading side 418 of moving tire 412, interstices 210 are at least partially empty and strip 202 (FIG. 2) thereby persistently presents a traction surface to roadbed 420.

An embodiment of the invention is constructed as follows: an adhesive is applied to one side of a sheet of polybutene-plasticized natural rubber, the sheet being of a width suitable for application to the surface of a tire, typically 10 to 15 centimeters, and of a length that is long enough to provide appropriate traction but is preferably short enough to permit easy application to a tire mounted on the wheel of a vehicle, as discussed in more detail below. The adhesive is suitably formulated for adhesion to a cold and somewhat moist tire surface. One such adhesive comprises a mixture of hydrogenated rosin glycerol ester and maleated rosin glycerol ester. After application of the adhesive to the rubber sheet, a backing of paper or other protective material is applied to the surface of the adhesive to protect and preserve the adhesive until the sheet is prepared for application to a tire.

A polyurethane glue such as Gorilla Glue is applied to the reverse side of the rubber sheet and then dry discrete objects of a hard material, such as gravel, are positioned on the wet glue so as to leave spaces, typically of 5 to 10 millimeters, between objects. The objects are typically 5 to 12 millimeters along major axes and as thin as 2 to 3 millimeters in thickness, and may comprise, by way of example, #8 river gravel or appropriately sized lava rock. After the objects are positioned, the glue is allowed to cure at normal room temperature and humidity. Excessive humidity in the curing process is to be avoided, as this will cause the liquid polyurethane glue to foam excessively, filling in the interstices between the objects and reducing the utility of the invention. When the glue has hardened, the invention is ready for use.

To prepare the invention for application to a tire, the backing on the adhesive side of the sheet is removed and discarded. The leading edge of the tire exposed above the roadbed should be wiped so that it is relatively clean and dry. The adhesive side of the sheet is then pressed by hand onto the exposed surface of leading edge of the tire along its circumference. Strips should be of such a length as to provide traction along a good portion of the circumference of the tire, but should be short enough so that they can be readily applied to the exposed surface of the tire along its circumference from the roadbed up to a still-accessible portion of the tire within the vehicle wheel-well. In practice, a length of 17 to 30 centimeters may be used. Successive sheets may then be applied to further portions of the tire that are exposed between the wheel-well and the roadbed as the vehicle moves forward. In use, the applied sheets will adhere to the tire surface for a limited period of time dependent upon conditions of temperature, moisture and condition of the tire surface as well as characteristics of the particular adhesive used in manufacture of the invention. Under typical conditions, some embodiments adhere for 15 to 30 kilometers of use. In any case, so long as the sheets adhere to the tire, the vehicle is enabled to gain and maintain traction.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above. While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the claims and their equivalents.

I claim:

1. A device to enhance vehicle tire traction, the device comprising:
a flexible strip having two surfaces, on the first surface of which is deposited an adhesive material compounded to adhere the strip to the surface of a tire, and on the second surface of which are deposited hard objects affixed to the strip, the objects so distributed that the mean distance between two adjacent such objects is about 5 to 10 millimeters.

2. A device according to claim 1, wherein the hard objects are 5 to 12 millimeters in width, 5 to 12 millimeters in length, and more than 2 millimeters in thickness.

3. A device according to claim 2, wherein the hard objects are pieces of gravel.

4. A device according to claim 2, wherein the hard objects are pieces of lava rock.

5. A device according to claim 2, wherein the strip is about 10 to 15 centimeters in width.

6. A device according to claim 2, wherein the strip is about 15 to 40 centimeters in length.

7. A device to enhance vehicle tire traction, comprising:
A plasticized rubber sheet having two surfaces, on the first surface of which is deposited layer of adhesive, the adhesive comprising a mixture of hydrogenated rosin glycerol ester and maleated rosin glycerol ester, and on the second surface of which are affixed pieces of rock, such pieces 5 to 12 millimeters in width, 5 to 12 millimeters in length and at least 2 millimeters in thickness, the pieces of rock affixed to the second surface of the sheet with polyurethane glue and disposed on the sheet to leave an average of 5 to 10 millimeters between adjacent pieces of rock.
